(19) United States
(12) Patent Application Publication
(10) Pub. No.: US 2017/0021460 A1
(43) Pub. Date: Jan. 26, 2017

(54) FILLER METAL AND MANUFACTURING METHOD THEREOF

(71) Applicant: Rexwell Co., Ltd., Incheon (KR)

(72) Inventors: Eung Dug Park, Incheon (KR); Bo Young Lee, Gyeonggi-do (KR)

(21) Appl. No.: 15/104,937

(22) PCT Filed: Dec. 18, 2014
(86) PCT No.: PCT/KR2014/012513

§ 371 Date: Jun. 15, 2016

(30) Foreign Application Priority Data
Dec. 18, 2013 (KR) 10-2013-0158155
Jul. 8, 2014 (KR) 10-2014-0085141

(51) Int. Cl. B23K 35/02; B23K 35/40

(52) U.S. Cl. CPC B23K 35/0261; B23K 35/0266; B23K 35/0272; B23K 35/40

(57) ABSTRACT

The present invention relates to a filler metal used in welding of a metal material comprises a number of line material groups in various arrangements in a manner that a parent material is rolled onto a flat plate of below 1 mm in a first rolling process, the rolled plate is cut in a first rolling process to form a diameter φ of the line material of below 1 mm (φ<1 mm), a plurality of line materials are cleaned, rolled, heat-processed and cold-worked in turn to form the diameter of several mm<φ<0.3 mm, a plurality of the line materials are combined with each another in a number of bundle arrangements to form a group, and a number of the line material groups are combined with each another to form a core material and a manufacturing method thereof.

### TECHNICAL FIELD

The invention is related to providing a filler metal, and in particular, to providing a filler metal forming a plurality of wires or line materials in a micro-diameter, combining a predetermined number of the line materials in a number of bundle arrangements with each another to form a group and integrating a plurality of the groups of the line materials with each another to form a core material, thereby manufacturing an original material of a welding rod to be used in the welding of a metal material and a manufacturing method thereof.

### BACKGROUND ART

In general, a filler metal for forming a bead resulted from being melted by a heat source in the welding of metal materials is made in a welding rod or welding wire form as a filler metal.

There are problems in that a conventional welding wire requires its flexibility due to the transition from a wound state to an unwound one, its maximum diameter, for example 1.4 mm in case of the manual operation, is restricted and its productivity is not getting better due to a limit in raising an amount of current.

Also, the conventional welding wire requires a larger stiffness for the feed ability. Typically, it has a problem in that due to a lower stiffness in case of aluminum alloy lacking of the feed ability lowers the work efficiency or workability.

Furthermore, the conventional filler metal comprises a single solid that first the composition of an alloy must be determined upon the selection of a welding material. Due to it, its composition can't be changed in a next process. It has a problem in that a welding material having various compositions is easily made.

There has been a continuous molding technology as a method of preparing the conventional single solid. But, due to a number of the elongation and heat-process procedures of an ingot, it has problem in that its somewhat complex procedures and accompanying cost increase happen.

Therefore, it is very preferable if the complex procedures are decreased and the efficiency compared to the manufacturing cost is raised without using the continuous casting technology in manufacturing the filler metal.

It is also preferable if the filler metal is constructed as a single or group to enable the application of a high current and the increase of a melting and welding speed.

### DISCLOSURE OF THE INVENTION

### Technical Problem

A main object of the invention is to provide a filler metal forming a plurality of wires or line materials in a micro-diameter, combining a predetermined number of the line materials in a number of bundle arrangements to each another to form a group and integrating a plurality of the groups of the line materials with each another to form a single core material, thereby applying a higher current thereto and increasing the melting and welding speed and manufacturing method thereof.

Other object of the invention is to provide a filler metal for reducing the procedures of manufacturing a line material in a micro-diameter and enhancing the productivity without using the continuous casting technology in manufacturing thereof and manufacturing method thereof.

### Technical Solution

According to one embodiment of the invention, a filler metal is constituted as a number of bundle structures comprising a plurality of line materials.

According to the other embodiment of the invention, a filler metal is a welding rod that comprises a welding rod of line materials in a rod form or a welding wire in a continuous wire form, in which a diameter φ of each of the line material is preferably several μm<φ<1 mm.

According to another embodiment of the invention, a filler metal is configured so that a part of the line materials is higher than other ones in the diameter.

According to another embodiment of the invention, a filler metal is configured that a plurality of line materials are stranded with each another in a lengthwise

According to another embodiment of the invention, a filler metal comprises groups of a plurality of line materials that enables the arrangement of the groups of line materials adjacent to each another.

According to another embodiment of the invention, a filler metal comprises a plurality of line material groups arranged at a predetermined angle on a concentric circle, at the center of which one group of the line materials is positioned.

According to another embodiment of the invention, a filler metal are arranged so that line materials positioned on the outside is larger than ones on the inner in a diameter,

According to another embodiment of the invention, a filler metal comprises a flux core at the center thereof on the circumference of which pluralities of the line materials are arranged.

According to another embodiment of the invention, a filler metal comprises a plurality of line materials integrally coating a flux on the exterior circumference thereof.

According to another embodiment of the invention, a filler metal comprises a plurality of the line materials on each of which a copper is plated.

According to another embodiment of the invention, a filler metal comprises a plurality of line materials onto the outside surface of which a tube is covered or caped.

According to another embodiment of the invention, a filler metal comprises a plurality of line materials that is alloyed with any one of Fe, Ni, Al, Mg, Cu, Ti, Co, Zr, Nb, Mo, etc. or their alloys.

According to another embodiment of the invention, a filler metal comprises a plurality of line materials, a part of which is made of components different from other line materials.

According to one embodiment of the invention, a manufacturing method of a filler metal for welding a metal material comprises steps of first rolling a parent material onto a flat plate of below 1 mm, cutting the rolled plate to form a diameter φ of the line material of below 1 mm (φ<1 mm), then cleaning, stretching, heat-processing and cold-working a plurality of line materials in turns to form the diameter of several μm<φ<0.3 mm, combining a plurality of the line materials processed to each another in a plurality of bundle arrangements to form a group and combining a number of the line material groups to each another to form a core material.

According to the embodiment of the invention, the manufacturing method of the filler metal further comprises a second rolling process of performing another heating-proces sing and rolling processing of the flat parent material so that a thickness of the flat plate is rolled by 0.3 mmm.

According to the manufacturing method of the invention, a filler metal is made in various diameters of 0.8φ, 1.2φ, 1.4φ˜30.0φ etc. in a manner to form a group of line materials combining a plurality of line materials in a micro diameter in a bundle arrangement with each another and then combine a number of line material groups with each another.

Therefore, according to the embodiments of the invention, the filler metal can perform the covered arc welding, the protection gas metal arc welding, the sub-merged arc welding, the tungsten inert gas welding, the plasma welding, the laser welding, the electron beam welding, the electro slag welding, the electro gas welding, etc.

### Advantageous Effects

According to the embodiments of the invention, a filler metal and manufacturing method thereof improves the productivity without using the continuous casting technology, the line materials forming the filler metal can be made as the smaller ones in a micro-diameter to form a higher specific surface area of each line material, thereby increasing the melting and welding speed, and the melting depth thereof is increased, thereby enhancing the welding quality and productivity.

### BRIEF DESCRIPTION OF THE DRAWINGS

The drawings showing embodiments of the invention will be briefly explained as follows:

FIGS. 1 and 2 are cross-sectional and perspective views illustrating a filler metal made by using a plurality of line materials according to one embodiment of the invention;

FIG. 3 is a cross-sectional view illustrating a filler metal made by using a plurality of line materials according to a second embodiment of the invention;

FIG. 4 is a cross-sectional view illustrating a filler metal made by using a plurality of line materials according to a third embodiment of the invention;

FIG. 5 is a cross-sectional view illustrating a filler metal made by using a plurality of line materials according to a fourth embodiment of the invention;

FIG. 6 is a cross-sectional view illustrating a filler metal made by using a plurality of line materials according to a fifth embodiment of the invention;

FIG. 7 is a cross-sectional view illustrating a filler metal made using a plurality of line materials according to sixth embodiment of the invention;

FIG. 8 is a cross-sectional view illustrating a filler metal made by using a plurality of line materials according to a seventh embodiment of the invention;

FIGS. 9 to 13 are graphs and photographs illustrating test examples of a welding method for using a filler metal constituted as a plurality of line materials according to the embodiments of the invention;

FIG. 14 is a schematically upper view illustrating a parent material of a filler metal to be processed according to the principal of the invention; and,

FIG. 15 is a flow chart illustrating procedures of manufacturing the parent material of the filler metal according to the principal of the invention.

### MODE FOR CARRYING OUT THE INVENTION

The invention will be described in detail with reference to the attached drawings as follows:

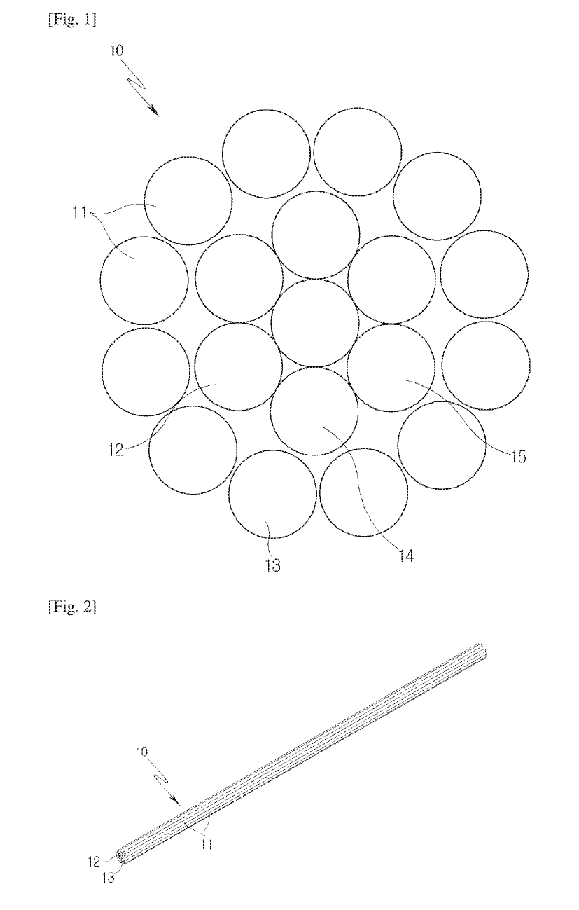

FIG. 1 shows a cross-section form of a filler metal 10 including a plurality of line materials 11, 12, 13, 14, 15. The filler metal 10 comprises a number of bundle arrangements including the line materials 11, 12, 13, 14, 15 made in the same shape and diameter, in which six line materials around one line material at the center are arranged in a first row and then twelve line materials are arranged in a second row around the first row.

FIG. 2 shows a perspective view of the filler metal 10. The filler metal can be made as a welding rod 10 of a bar shape by forming the line materials 11, 12 and 13 in a number of bundle arrangements as well as constructed as a welding wire not shown in the form of a continuous wire.

The filler metal comprises a welding rod or a welding wire as well as a plurality of thin line materials.

Each of the line materials 11, 12, 13, 14, 15 is formed to have a diameter φ of a few μm<φ<1 mm, preferably 1 μm<φ<1 mm. More preferably the line material is made below 0.3 mm. As such like thin micro-line materials 11, 12, 13, 14, 15 are constructed as a number of bundle arrangement, a surface area in contrast with a total cross-sectional one becomes larger. The increased surface area enables the use of a current per a higher unit area rather than one that is used at an area of the same diameter. Herein, each of the line materials 11, 12, 13, 14, 15 can be plated, particularly by a copper (Cu) around the exterior circumferential surfaces thereof, so that their conductivity may get higher.

Also, if the welding rod or the welding wire includes the line materials 11, 12, 13, 14, 15 of a thin cross-section, it raises a melting speed under the condition of the same arc energy to enhance the welding speed as well as heightens the concentration degree of an arc to deepen the depth of penetration. Together with it, the stability of an arc is enhanced, the size of a volume becomes smaller, and a number of the welding performance is increased, so that the occurrence of spatter is reduced. The detailed explanation will be made based on Test Examples as follows:

On the other hand, if the line materials 11, 12, 13, 14, 15 in a thin micro-line shape structure is constructed as a number of bundle arrangements, their flexibility become larger than a general single line. Upon welding operation, it is easy to handle them, so that the line materials of a diameter larger than that of the general one is usable. Thanks to it, the higher current rather than one used in past is usable, thereby increasing the productivity.

Herein, it is noted that if the welding wire includes only thin line materials 11, 12, 13, 14, 15, the flexibility gets higher, but the feed ability becomes lower.

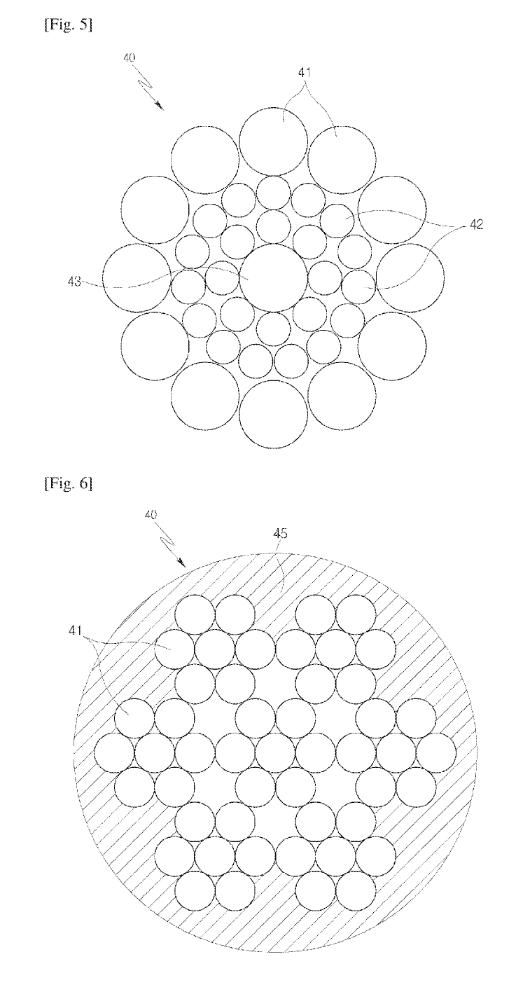

As shown in FIG. 5, a filler metal 40 comprises line materials 41 of a diameter larger than that of the other line materials 42. Like this the mixing arrangement of the larger line materials and the other smaller line materials 42 in a diameter can enhance the stiffness and the feed ability compared with the filler metal including only thin line materials 42.

The line materials 41 positioned on the outer circumference of the filler metal 40 may be formed in a diameter larger than that of the line materials 42 positioned on the inner thereof, and in the other manner the thick line materials 42 may be arranged at the center of the thin line materials 41. Also, line materials 41, 43 of a relatively large diameter may be uniformly distributed among the other line materials 42 (not shown).

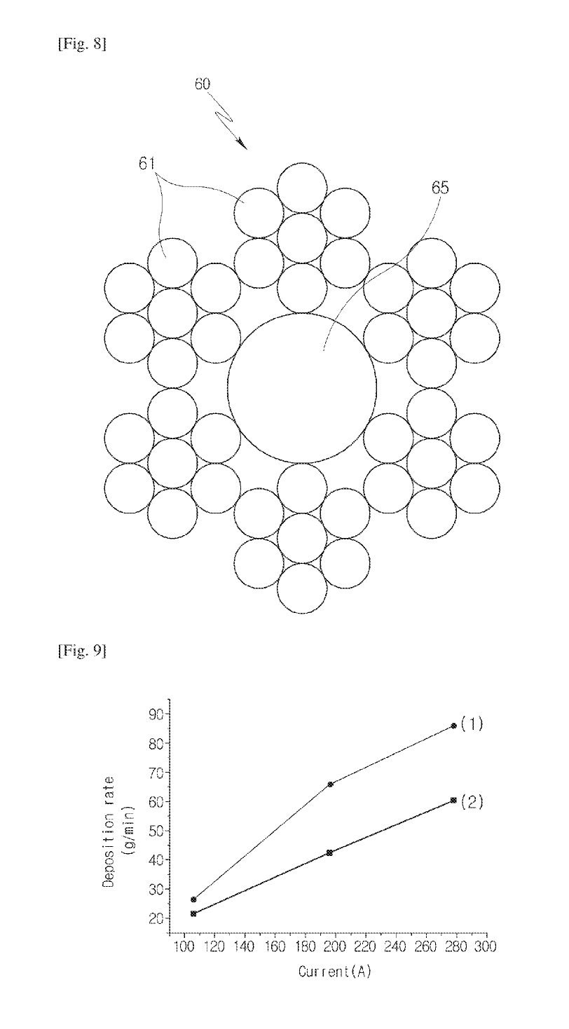

As shown in FIG. 8, a filler metal 60 comprised a flux core 65 or a flux cored wire at the center thereof, around the circumference of which a plurality of line materials 61 are arranged. Like this the flux core 65 is provided at the center of the line materials 61 to increase the stiffness, thereby enhancing the feed ability and workability.

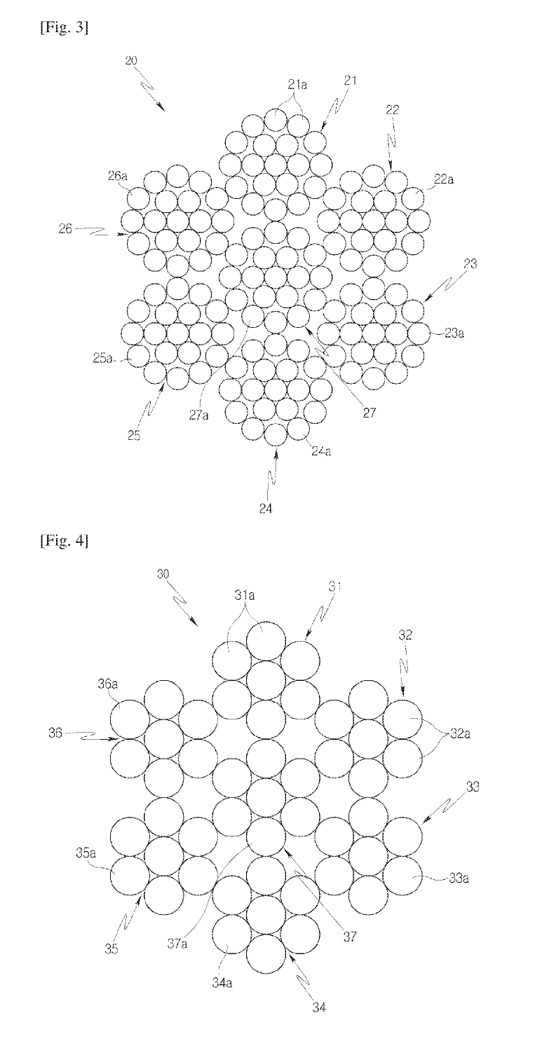

Referring to FIG. 3 again, the filler metal 20 comprises a plurality of line material groups 21, 22, 23, 24, 25, 26, each group of which includes a plurality of line materials 21a, 22a, 23a, 24a, 25a, 26a, 27a formed in one group arrangement adjacent to each another.

Referring to FIG. 4, line materials 31a, 32a, 33a, 34a, 35a, 36a, 37a are different in the diameter and the number from the line materials 21a, 22a, 23a, 24a, 25a, 26a, 27a of FIG. 3, and the number of line material groups 31, 32, 33, 34, 35, 36, 37 is the same as that of the groups of FIG. 3.

A plurality of the line material groups 21, 22, 23, 24, 25, 26, 27 and 31, 32, 33, 34, 35, 36, 37 are arranged at a predetermined angle (60° in case of FIGS. 3 and 4) on the same circumference of a circle, at the center of which each of the line material groups 27, 37 is positioned.

A plurality of the line material groups may be arranged in a random state adjacent to each another in disorder different from those of FIGS. 3 and 4, which is of course belonged to the scope of the invention.

For example, a plurality of the line materials may be adhered/fixed by an adhesive to each another and formed in a stranded state along the longitudinal direction like a rope (not shown).

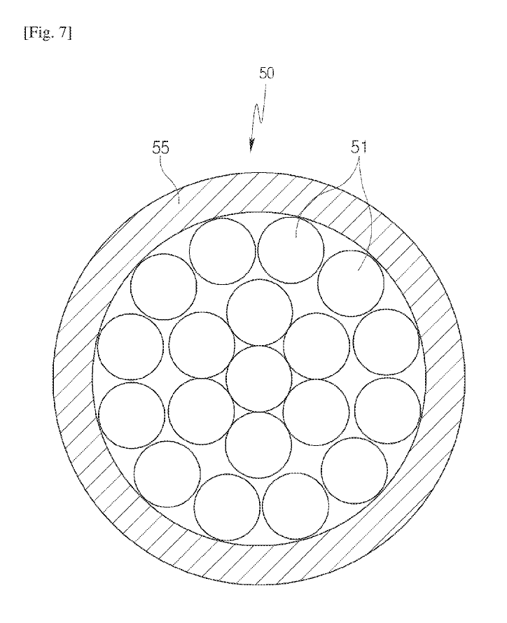

Also, a filler metal 40 may comprise a separate fixing means on the exterior surface of all of the line materials made in a number of bundle arrangements. For example, as shown in FIG. 6, the filler metal 40 comprises a plurality of line materials 11 constructed in a number of bundle arrangements, on the outer circumference of which a flux 45 may be integrally coated. As shown in FIG. 7, a filler metal 50 comprises a plurality of line materials 51, on the outer circumference of which an angular tube 55 may be covered.

The flux 45 is integrally molded with the line materials 41 in a manner to be placed in a space between the line materials 41, thereby fixing the line materials 45 to each another. The tube 55 is made in an annular tube form independent of the line materials 51 to maintain vacant spaces between the line materials 51. In other word, the flux 45 is filled in spaces between the line materials 41 to remove vacant spaces there between, but the tube 55 covers only the whole outer circumference of the line materials 51 to leave the vacant spaces there between.

As described above, each of line materials 21a˜27a, 31a˜37a, 41, 51, 61 is formed in a diameter φ of a few μm<φ<0.3 mm, preferably smaller than 0.3 mm. If the line materials 21a˜27a, 31a˜37a, 41, 51, 61 constructed as a thin micro-line material like this are constructed in a number of bundle arrangements, a surface area in contrast with a total cross-sectional area becomes larger. The increment of the surface area enables the use of a current per an area of a higher unit than that usable in the same diameter.

Also, if a welding rod or welding wire includes the line materials 21a˜27a, 31a˜37a, 41, 51, 61 of a thin cross-section, it can increase the melting speed and the welding speed at the same time, and if a degree of the arc concentration becomes higher, the depth of penetration can become larger. Besides, the stability of an arc is enhanced, the size of a welding volume becomes smaller, and a number of the welding performance is increased, so that the occurrence of spatter is reduced.

Such like line materials 21a˜27a, 31a˜37a, 41, 51, 61 constructed as thin micro-line materials can increase the productivity thanks to a simple and easy method of producing a parent material 1 into a flat plate without using the continuous casting the technology.

The line material comprises any one of Fe, Ni, Al, Mg, Cu, Ti, Co, Zr, Nb, Mo, etc. and their alloy.

The line materials may be in part made of compositions different from the other ones. For example, as shown in FIG. 1, in part the line materials 12, 13, 14, 15 may be made of Ni, Al, Cu, Ti, and the other line materials 11 are made of Fe.

After the micro-line materials comprising basic compositions like this are produced, respectively, they are compositely mixed with each another to make a necessary composition of a filler metal. Thanks to it, a welding material having various alloy compositions can be easily produced.

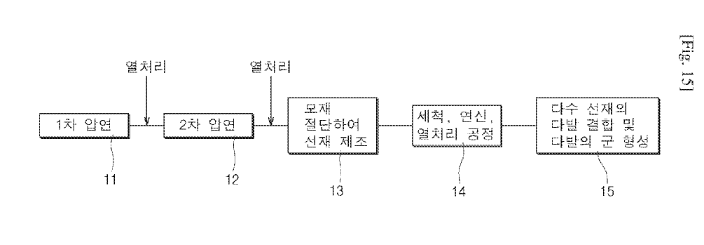

As shown in FIG. 14, according to one embodiment of the invention a parent material 1 is previously prepared as a flat plate for the production of a plurality of line materials which are constituted as a filler metal.

As shown in FIG. 15, in step 11 the parent material 1 is made in a rolling process to form a flat plate, and the rolled plate is cut below a thickness of 1 mm to form a line material of a diameter φ of φ<1 mm, in which step 11 is called a first rolling process for convenience sake.

Step 11 goes onto step 12 to heat-process, cold-work and again roll the first rolling processed flat plate if needed, so that the thickness may be made below 0.3 mm, in which step 2 is called a second rolling process. In any case, based on a rolling capacity and material characteristics the first and second rolling processes can be executed at the same time.

In step 13, the rolled plate 2 through the first and second rolling processes is cut to make a plurality of line materials having a diameter φ of φ<1 mm or φ<0.3 mm.

In step 14, a plurality of line materials are processed in a manner to selectively perform the procedures of the washing, stretching, heat-processing, cold-working, etc. and let the diameter φ of the line material to be formed in the range of a few μm<φ<0.3 mm.

In step 15, pluralities of line materials are combined in a number of bundle arrangements to form a group, and then a number of the line material groups are combined with each another to make a filler metal of various embodiments as above.

Therefore, according to the invention, a filler metal can be adapted to the covered arc welding, the protection gas metal arc welding, the sub-merged arc welding, the tungsten inert gas welding, the plasma welding, the laser welding, the electron beam welding, the electro slag welding, the electro gas welding, etc.

The welding was tested using one filler metal according to the invention. The result was compared with a conventional welding rod. The test examples will be explained as follows:

### TEST EXAMPLES

Characteristics according to one embodiment of the invention will be explained in light of the test results as below:

The specification (SPEC) of samples used in the test is showed in Table 1.

TABLE 1

| Cross-sections | Prior Art 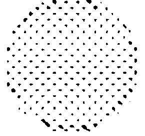 | 1 × 7(EA) 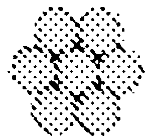 | 1 × 19(EA) 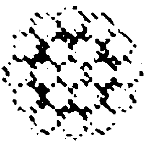 | 7 × 7(EA) 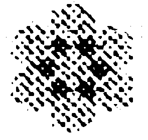 | 7 × 19(EA) 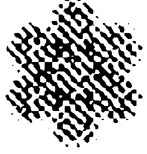 |
|---|---|---|---|---|---|
| Diameter of Line | 12 | 0.4 | 0.24 | 0.14 | 0.09 |
| Material(mm) | | | | | |
| Cross-sections | 1.13 | 0.88 | 0.86 | 0.75 | 0.84 |
| (mm²) | | | | | |
| Surface Length | 3.8 | 8.7 | 14.3 | 21.5 | 37.5 |
| (mm) | | | | | |
| Surface | 3.3 | 10 | 16.6 | 28.5 | 44.4 |
| Length/Cross- | | | | | |
| sections | | | | | |

Length and Cross-Sectional area of Surface Based on Shape of Line Material

[Table 2] and [Table 3] are test values which compares the melting and welding speed of a filler metal including line materials according to the invention with a welding rod of a single line according to a prior art.

TABLE 2

| | Melting | Melting | Substantial | Welding |
|---|---|---|---|---|
| | Length | Speed | Measurement | Speed |
| Kind of Line | (mm) | (mm/min) | (kg/h) | Ratio |
| Solid (Single Line) | 787 | 4,292 | 2.32 | 1 |
| (Prior art) | | | | |
| Plural Lines (1 × 19) | 1285 | 7,009 | 2.89 | 1.24 |
| (Invention) | | | | |

Comparison of Melting Speed (175 A, 25V)

TABLE 3

| | | Substantial Measurement | Single Reference |
|---|---|---|---|
| Condition | Kind of Line | (kg/h) | Comparison |
| 106A | Solid (Prior art) | 1.296 | 1 |
| | Plural Lines | 1.584 | 1.22 |
| | (Invention) | | |
| 197A | Solid | 2.556 | 1 |
| | Plural Lines | 3.960 | 1.55 |

Welding Speed Comparison by Each of Current Intensities

Referring to Table 2, it is known that an amount of the melting per hour is increased, and then the welding speed is raised up by 24% comparing with that of a prior art.

Also, referring to Table 3, it can be identified that the welding speed of a welding wire according to the invention is raised up by about 22% in case of the application of a welding current of 106 A, by about 55% in case of the application of a welding current of 197 A and by about 43% in case of the application of a welding current of 280 A. FIG. 9 are graphs showing the welding speed of the welding wire 1 and a conventional welding wire 2 of a solid or a single line. Herein, it is known that the welding speed difference occurs by the height one between Graphs (1) and (2).

As a result, it is known that the welding efficiency is enhanced by over 20%. That is because the diameter of the welding wire including thin line materials is reduced to increase the welding speed.

TABLE 4

| Current (A) | | Voltage (V) | Mita Index |
|---|---|---|---|
| 165 | (Solid/Prior art) | 26 | 6.40 |
| | (Plural Lines/Invention) | | 1.35 |
| 230 | (Solid) | 33 | 5.75 |
| | (Plural Lines) | | 4.24 |
| 295 | (Solid) | 33 | 5.58 |
| | (Plural Lines) | | 3.62 |

Arc Stability Comparison Mita Index
Herein, Modified Mita Index = ln(S(Tₐ) × S(Tₛ)),
Tₐ: Arc Time Standard Deviation,
Tₛ: Short Time Standard Deviation

It is identified in Table 4 that the welding wire according to the invention has the arc stability larger than that of the conventional solid wire.

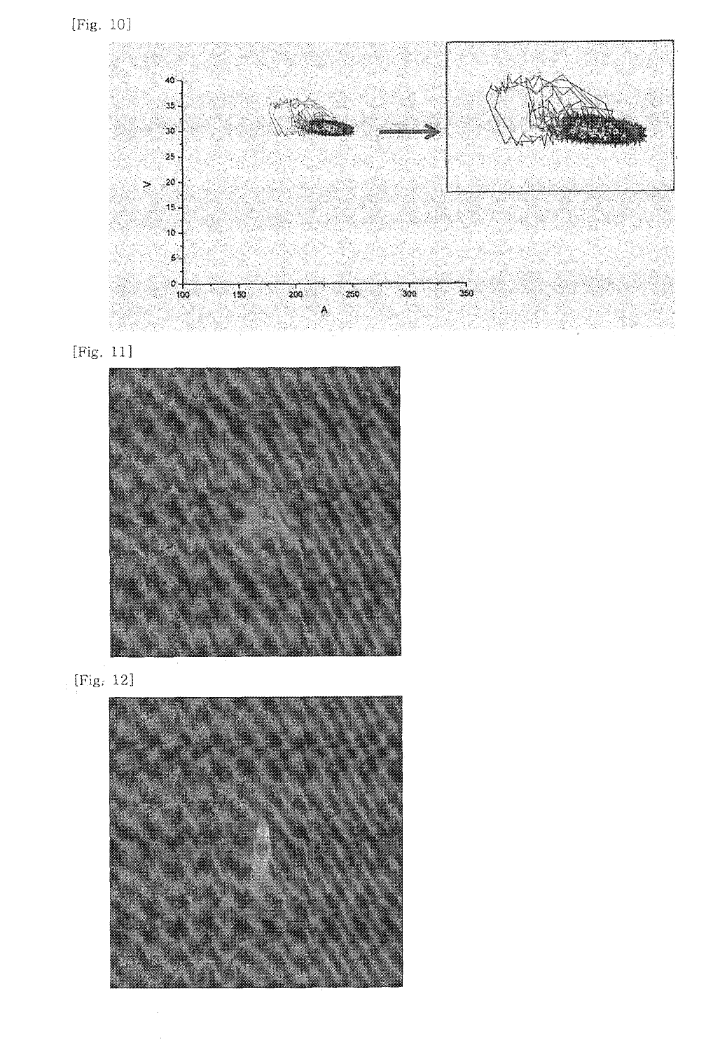

Also, FIG. 10 is a graph showing a characteristic of Current-Voltage. It is identified from the graph that the arc stability of the welding wire according to the invention was enhanced. For example, the thick portion at the right shows the current-voltage characteristic corresponding to the invention, and the curved lines widely distributed from the left shows that corresponding to the conventional solid welding wire. If the welding is performed using the welding wire according to the invention, it shows that the variation width of the current-voltage is narrow.

FIGS. 11 to 13 show arc phenomena upon welding (under conditions of 284 A, 32V).

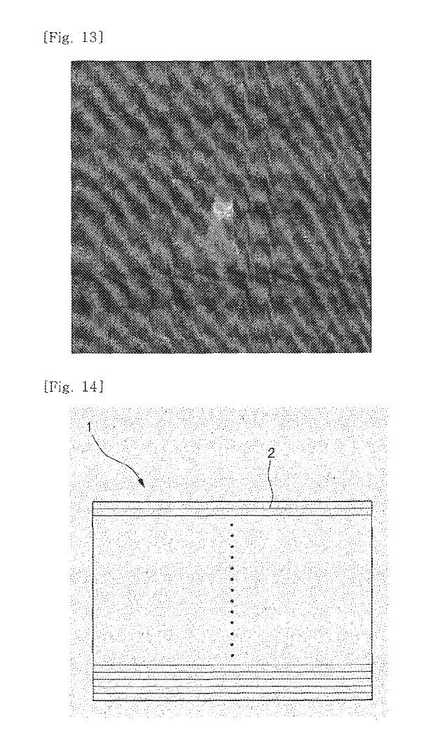

FIG. 11 is an arc phenomenon in case of welding using a conventional solid wire or single line, and FIGS. 12 and 13 are arc phenomena of welding in time of using a welding wire of the invention.

It is identified that the arc spreading phenomena shown in FIGS. 12 and 13 is narrower than that shown in FIG. 11.

As described above, the invention is suggested based on the detailed embodiments. It is for explaining the invention in detail, but the invention is not restricted thereto. It is clearly apparent that the invention can be changed or improved within the scope of the invention by an ordinary person skilled in the art to which the invention pertains.

The simple modifications or variations are belonging to the scope of the invention. The detailed protect scope of the invention will be apparent by patent claims attached.

1. A filler metal used for welding a metal material comprising:
a plurality of line materials including a thin micro-line material body made in a bundle arrangement and then a number of bundle arrangements formed in a line material group; and
a plurality of line material groups combining a number of bundle arrangements with each other.

2. The filler metal used for welding the metal material of claim 1, wherein the line materials are made in the bar shape.

3. The filler metal used for welding the metal material of claim 1, wherein each of the line materials is made in the form of a continuous wire.

4. The filler metal used for welding the metal material of claim 1, wherein each of the line materials has a diameter φ of 1 μm<φ<0.3 mmφ<0.3 mm.

5. The filler metal used for welding the metal material of claim 1, wherein a part of each of line materials has a diameter larger than that of the other line materials.

6. The filler metal used for welding the metal material of claim 1, wherein the line materials are stranded along their lengthwise to each another.

7. The filler metal used for welding the metal material of claim 1, wherein a number of line material groups are arranged at an angle on the same concentric circle.

8. The filler metal used for welding the metal material of claim 1, wherein a number of line material groups comprise further one line material group at the center thereof.

9. The filler metal used for welding the metal material of claim 1, wherein the line materials positioned on the outer portion have a diameter larger than those on the inner portion.

10. The filler metal used in welding of the metal material of claim 1, wherein the filler metal comprises further a flux core at the center thereof and a plurality of line materials around the flux core.

11. The filler metal used for welding the metal material of claim 1, further comprising a flux that is integrally coated around the outer circumference of the line materials.

12. The filler metal used for welding the metal material of claim 1, wherein the outer surface of each of line materials is plated by a copper (Cu).

13. The filler metal used for welding the metal material of claim 1, further comprising a tube that is covered onto the outer circumference of line materials.

14. The filler metal used for welding the metal material of claim 1, wherein the line materials are made from at least one material selected form the group consisting of Fe, Ni, Al, Mg, Cu, Ti, Co, Zr, Nb, and Mo.

15. The filler metal used for welding the metal material of claim 1, wherein a part of the line material is made of components different from the other line materials.

16. A manufacturing method of a filler metal used for welding a metal material comprising:
rolling a parent material onto a flat plate of below 1 mm in a first rolling process;
cutting the rolled plate by the first rolling process to form a diameter φ of the line material of below 1 mm (φ<1 mm);
cleaning, stretching, heat-processing and cold-working a plurality of line materials in turn to form the diameter of several μm<φ<0.3 mm; and
combining a plurality of the line materials with each another in a number of bundle arrangements to form a group and combining a number of the line material groups with each another to form a core material.

17. The manufacturing method of the filler metal used for welding a metal material of claim 16, further comprising second rolling that comprises heat-processing, cold-working and rolling the flat parent rolled in the rolling step, again, to have a thickness of the flat plate rolled at below 0.3 mm.

18. The manufacturing method of the filler metal used for welding a metal material of claim 16, further comprising performing only any one of the rolling step and the second rolling step, and then another heating process and rolling process to control the diameter φ.

19. A filler metal used for welding a metal material comprising:
a parent material rolled onto a flat plate of below 1 mm in a first rolling process, the rolled plate cut in the first rolling process to form a diameter φ of the line material of below 1 mm (φ<1 mm); and
a plurality of line materials cleaned, rolled, heat-processed and cold-worked in turn to form the diameter of several μm<φ<0.3 mm, the line materials combined with each another in a number of bundle arrangements to form a group and the line material groups combined with each another to form a core material.

20. The filler metal used for welding the metal material of claim 19, wherein the line material groups formed in the bundle arrangement, and the line material groups combined with to each another to manufacture a core material in various diameters of 0.8φ, 1.2φ, 1.4φ˜30.0φ.
